(19) United States
(12) Patent Application Publication
(10) Pub. No.: US 2019/0188627 A1
(43) Pub. Date: Jun. 20, 2019

(54) SYSTEM FOR CREATING COLLABORATIVE PROJECT DATA

(71) Applicant: FIDELIUMTECH, INC., Austin, TX (US)

(72) Inventors: Gregory S. Hein, Fulshear, TX (US); Bryan Gerald Goerger, Plymouth, MN (US)

(21) Appl. No.: 16/219,473

(22) Filed: Dec. 13, 2018

Related U.S. Application Data
(60) Provisional application No. 62/598,677, filed on Dec. 14, 2017.

(51) Int. Cl. G06Q 10/06; H04L 9/06; G06F 16/176; G06T 19/00

(52) U.S. Cl. CPC G06Q 10/063118; G06Q 10/063112; G06Q 10/0639; G06T 19/006; H04L 9/0637; G06F 16/176; G06Q 10/063114

(57) ABSTRACT

A platform system for creating collaborative project data where a project collaborators create projects and content by inputting project information on a platform and recording the project information on a public or private blockchain. A plurality of data researchers collect data from various entities based upon the project information and then record the collected data on the blockchain. Collected data is selected based on criteria and payment made to the data researcher.

### CROSS REFERENCE TO RELATED APPLICATIONS

This application claims the benefit of U.S. Provisional Application No. 62/598,677 filed Dec. 14, 2017, the contents of this application is hereby incorporated by reference in its entirety.

### BACKGROUND OF THE INVENTION

This invention is directed to a system for creating, curating, and processing project data and more particularly a collaborative system having incentives for creating project content and data quickly and efficiently.

Typically, developing and acquiring information for a project is time consuming and labor intensive. The process involves making multiple calls to multiple entities to obtain information relevant to a project. If you are not familiar with the entity, additional research is done to evaluate their reputation, to establish trust. Current marketplace models lack efficiency particularly with respect to obtaining quotes and making payments, therefore creating a lack of trust. Further, information gathered for one project often is not made available for future projects requiring the process to be repeated, thus creating a much higher project cost than a project where information is not only communicated better amongst a project team but between similar projects. Accordingly, a need exists in the art for a system that addresses these deficiencies via the digitization of design via the ownership of creative content.

Since the invention of Blockchain, the Satoshi Nakamoto white paper has presented a revolutionary solution for creating digital trust. Bitcoin has been the most renowned use case for Blockchain within the financial sector. Other solutions have been presented as use cases for Blockchain, such as within supply chain management tracking and real estate transactions. This use case within project design and construction is unique. By design, Blockchain's purpose is to disintermediate the need for the middleman in most use cases, thereby allowing for peer-to-peer trust to create value by removing unnecessary steps that only add to the transactional costs. The construction industry use case is different because the middleman cannot be disintermediated as they must still contribute the labor and know-how to a project. This embodied use case does not disintermediate the middleman (contractor in the construction use case) but creates peer-to-peer trust between each entity (i.e. Data Researcher-Owner, Owner-Contractor, Data Researcher-Supplier, and the like) individually that chooses to engage in project execution with the proposed platform.

An objective of the present invention is to provide a system for creating collaborative project data and creative content that expedites the process of creating budgets (obtaining estimates) and contracting (smart contracts & specifications) for projects both initially from the shared data and the verification of said budgets and contracts with contractors that will do the work.

Another objective of the present invention is to provide a system for creating collaborative project data that reduces costs by sharing data for projects having similar parameters.

Another objective of the present invention is to provide a system for creating collaborative project data that links entities based upon reputation, verifiable experience, and scope of work involved in the project.

Another objective of the present invention is to provide a system for creating collaborative project data that allows for content to be created for use by the community for joint benefit, or more specifically where creative content ownership is owned and retained by the creator with a reward to the creator based on popularity of their content used, completeness of said content, and verification of correctness by an entity that would benefit from said content. In this case an entity could be a supplier of a product that has their product created by a researcher (gamer) in the ecosystem desirous of creating content for monetary reward.

Another objective of the present invention is to provide a system for creating collaborative project data that allows product suppliers a vehicle with which to present their products directly to the entity using the product in a project. In this case a supplier could sell their products on the platform, dynamically update their pricing and product offerings directly to their consumers without an intermediary, provide associated product warrantees and consumer updates, thereby enabling for the first time a relationship between the consumer and the product supplier.

Another objective of the present invention is to provide a system and network for the use of the collaborative project data that allows for the entities using the platform to learn and create curriculums for training via simulation. In this case an entity could achieve verifiable levels of educational attainment that can be used outside the platform to complement existing educational curriculums or as a means to an equivalent technical training at a lesser cost.

These and other objectives will be apparent to those having ordinary skill in the art based upon the following written description, drawings, and claims.

### SUMMARY OF THE INVENTION

A system for creating collaborative project data includes the creation of a project by a project owner by inputting project information onto a platform that is recorded in a public or private blockchain. Associated with the project is an incentive and selection criteria.

Based on the project information and selection criteria, a plurality of data researchers collects data from third party entities or from current content that resides within the platform. The collected data is recorded on the blockchain and stamped with signatures of immutability.

The system executes a smart contract between the project owner and all entities related to the selected content and rewards the data researcher associated with the selected content. Inputs are made to the recorded content through the platform upon scope of work milestones, validated completion metrics, and certified completion. Based on inputs and certified completions, the platform initiates new execution provisions for the project and triggers payment to selected entities.

The platform also assigns a value to the collected data recorded on the blockchain for payment of the value to the data researcher based upon future use of the recorded collected data. Each data researcher/contributor/owner/contractor may be evaluated by the platform and given a rating based upon their performance. Such ratings may then be used to certify certain experience working on the platform, certify attainment of training certifications, certify a dollar amount of total experience through the platform, and other such objective and subjective metrics as deemed necessary for the platform.

### BRIEF DESCRIPTION OF THE DRAWINGS

FIG. 1 is a schematic block diagram of the environment for a system for creating collaborative project data;

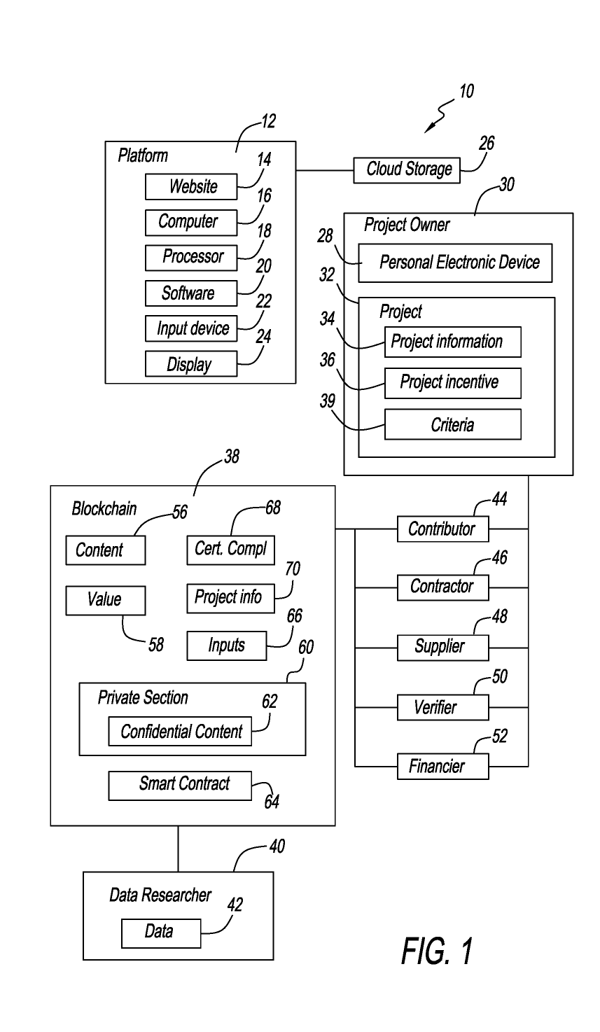

FIG. 2 is a flow diagram of a system for creating collaborative project data; and

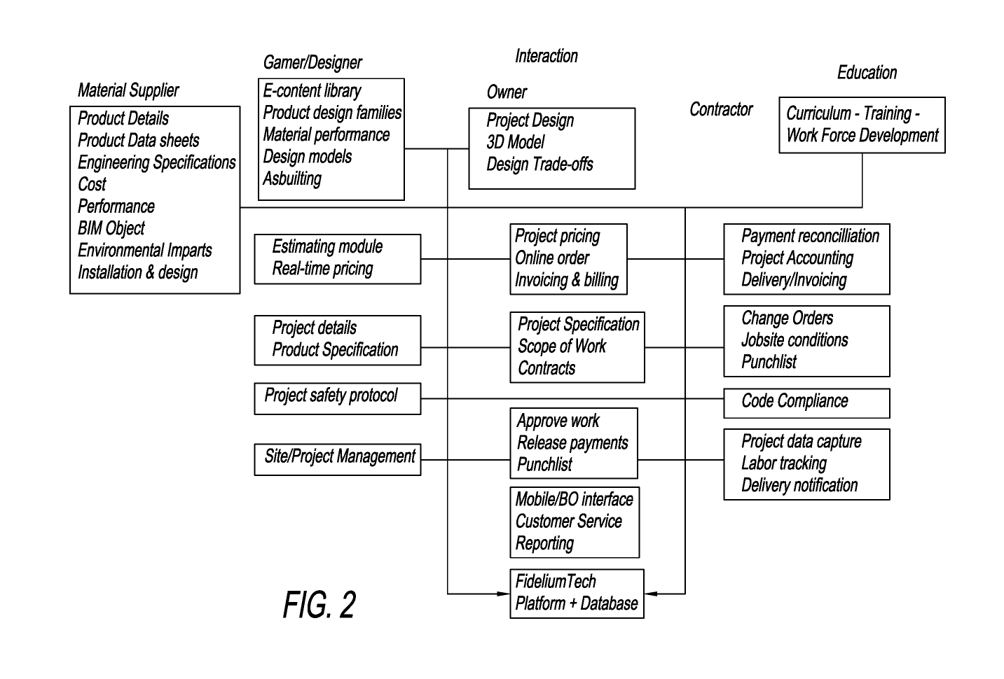

FIG. 3 is a flow diagram of a system for creating collaborative project data.

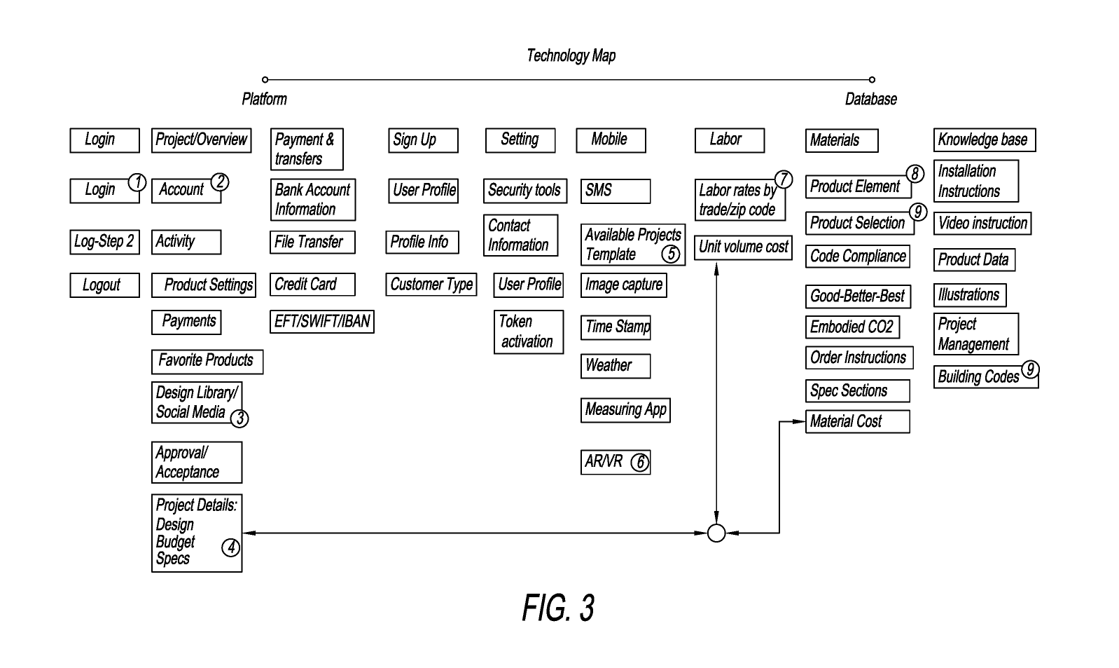

### DETAILED DESCRIPTION OF THE PREFERRED EMBODIMENTS

Referring to the Figures, a system for creating collaborative project data 10 includes a platform 12 having a website 14 connected to a computer 16 having a processor 18, software 20, input device 22, and display 24. The computer is connected to a cloud based storage 26.

The platform 12 is accessed via an electronic network from a personal electronic device 28 such as a computer, mobile phone, or the like, by any of the project stakeholders (30, 40, 44, 46, 48, 50, 52). Each of the stakeholders has a different experience with the platform, as each stakeholder has a different value exchange with the platform 12. A project owner 30 is the ultimate beneficiary of a project. Through the platform 12 the project owner 30 creates a project 32 by inputting project information or requirements 34. Through the platform 12 the data researcher creates a project 32 by inputting project information or requirements 34. The project 32 is of any type and for purposes of example only the project involves the construction of a house. The project information 34 input includes the specifications for the house including blue prints, structural requirements, building codes, soil conditions, architectural preferences or styles and any other information necessary to initially design and ultimately build the house. The project owner 30 also inputs a project incentive or price 36 he or she is willing to provide in return for the creation of data related to the project. The project owner may also review portfolios of content created within other projects and pull such project content (in the form of style or look) into their project. The project information 34 is recorded in a blockchain 38. Finally, the project owner 30 inputs criteria 39, such as least expensive, earliest completion time, a combination and the like.

Based on the published project information 34 a plurality of data researchers 40 compete to provide data 42 related to the project information 34 and earn the project incentive 36. The data 42 created related to the house project can include, but is not limited to, the price and availability of materials and labor recommended by the contributor 44, contractor 46, supplier 48, verifier 50, and/or financier 52.

The contributor 44 is one, such as a designer, engineer, or manager tasked with the development of creating a design of the home, or the scope of work (or product or service). The contractor 46 is the individual or entity contracted to build the home (product or provide the service) based on the designed scope of work for the project. The supplier 48 is any entity that contributes resources to the project whether it be labor, materials, or the like. The verifier 50 is any entity, such as an architect, engineer, quality assurance person or the like tasked with the verification that all work is designed and ultimately built to all requirements for the type of work being executed. Finally, the financier 52 is any entity that provides a source of project funding such as a bank, investor, government entity or the like.

The researchers 40 will collect and/or create data 42 from the public domain or information recorded on a public blockchain 38 by the contributor 44, contractor 46, supplier 48, verifier 50, and financier 52. The content 56 created by the researcher is recorded on the blockchain 38 wherein the content is stamped by the platform 12 with signatures of immutability permitting the researcher 40 and/or designees to benefit monetarily from the creation of the content 56. When recorded, the platform 12 assigns a value 58 wherein when the content 56 is used on a project 32 the researcher 40 is rewarded by payment of the value 58. The system associates all entities potentially needed for a project 32 that enables and expedites each entities' ability to execute all or part of a project 32 and record the corresponding content 56 on a digital ledger or blockchain 38.

The content 56 preferably is compatible with existing scheduling, estimating, and management software to populate and be dynamically utilized through the project 32 evolution. The content 56, through the platform 12 passes into a governing and cascading scope of work that keeps quantities and costs dynamic as the project evolves throughout the various phases of the project evolution. The content 56 is also compatible with existing data capture technologies, softwares and formats that work synergistically within a project 32. The content 56 is used for the project 32 as well as for future use by the community.

The blockchain 38 is publicly shared and similar to Bitcoin, Ethereum or other publicly accessible open sourced blockchains. The blockchain 38 also has a private section 60 where confidential content 62 is stored encrypted and accessed by those authorized.

The content blocks 56 are preferably of finite volume wherein the attributes or data 42 are modifiable. The content blocks 56 can be chunked together into larger blocks to enable easier and speedier assembly by the researcher 40. Any researchers 40 that may be new to the platform 12 must complete certain qualification training via the platform 12 to ascertain a skill level appropriate for assembling the platform content 56. The time spent by researchers 40 in training and contributing to the platform 12 is recorded and noted as a rating.

Upon reaching a predetermined deadline, selection of one or more recorded content blocks 56 and/or 62 are made by the project owner 30 or the platform 12 based on the set criteria 39. Upon selection a smart contract 64 is executed between the project owners and the entities related to the selected content that outlines the scope of the work and all other terms related to the project. The project owner 30 also compensates the researcher 40 the value 58 assigned to the recorded content block 56 and/or 62.

Project provisions are executed directly between the project owner 30 and selected entities based upon scope of work milestones and validated completion metrics all communicated and processed through the platform 12. Inputs 66 are made to the recorded content block 56 and 62 through the platform based upon certified completion 68. The inputs are entered as data only that trigger new execution provisions for the project. Also, project information 70 is uploaded to the digital ledger of the content block 56 and 62 such as photos, pour reports, quality reports, general reports, notes and the like. The platform 12 initiates immediate payment from the project owner 30 or financier 52 to selected entities upon acceptance of the certified completion 68, for example via a multi-sig wallet from an escrow account.

The content blocks 56 or 62 are maintained by the platform 12 to validate the data or content by authorized selected entities. The content 56 is searchable on the platform 12 preferably by the input of terms such as cost, schedule, labor, statistics, design, performance, assemblies, or the like. The platform 12 also evaluates the performance of researchers 40 and selected entities and awards points, provides a rating, or the like.

With respect to a commercial building example, the content 56 creates a similar utility of Building Information Management (BIM) elements that are compatible with BIM systems such as Revit, Tekla, Autodesk and the like. These elements are collaboratively built and developed among the selected entities. For example, a selected entity within the internal platform may build a three dimensional component for a vendor used as a BIM element. These elements, developed in this collaborative system's environment are preferably linked to attributes such as materials, labor, installation costs and the like by and between selected entities. Any such elements that may be created and are utilized outside of the platform 12 will be in a format which allows for the direction of content back to the platform 12 for incorporation into the project design. For example, a proprietary file format of type (.pfp or other format best suited to the interaction) that lies on the Home Depot website for any user that wants to incorporate an individual component into a design refers the owner back to the site to download to the platform 12 to thereafter incorporate the element into a new project 32 or to reference the element in their scope of work for the researcher 40 to utilize in the platform 12.

Researchers 40, contributors 44, contractors 46, suppliers 48, verifiers 50, and financiers 52 are able to create content blocks 56 to list materials, products, services and other resources for use with current or future projects. The system 10 provides for expedited bidding and cost estimates from executed projects with similar parameters. The researchers 40 content 56 may be created utilizing gaming systems 43 and may be created using a three dimensional gaming interface. Accordingly, it is also envisioned that the platform display 24 will enhance the user interface not only via the engagement of a fun interface like gaming, but also incorporate augmented reality, virtual reality, and the like. Finally, the content may allow for issuance of new forms of financing via traditional bank lending/financing, home equity lines of credit, insurance claims, crowd funding, initial coin offerings or the like to validate projects for funding for offering within the platform 12.

The system includes the following features.
The system where the collected data is recorded to a private blockchain.
The system where the transactions paid to from any of the parties on the platform may choose to pay or be reimbursed in fiat currencies or any platform approved cryptocurrencies.
The system where initial project specific data may be imported using 3D camera capture technology and imported into the platform for project development using real world measurements.
The system where initial project specific data may be imported using smart phone AR technology.
The system where initial project specific data may be imported using LIDAR technology.
The system where project specific assemblies are dynamically changed by the linkage of costs and product availabilities to a project by location.
The system where suppliers may integrate their product portfolios into the platform thereby leveraging the use of the platform as a sales tool.
The system where suppliers may utilize the network effect of the platform as a design platform for understanding changing customer behavior and interests related to projects.
The system where supplier SKUs and data are automatically updated and made available to the community for joint beneficial use on any and all projects.
The system where projects may be commercial building projects.
The system where projects may be industrial projects.
The system where projects are infrastructure projects.
The system where projects are prototypes or simulations for use in any 3D environment.
The system where projects may be purely creative design environments for enjoyment only.
The system where the platform connects owners to contractors via a reverse auction type matchmaking system. Thereby giving high quality leads to contractors that they can review a budget, scope of work and photos, prior to accepting the lead upon their indication of interest to bid.
The system where the pricing of the project scope is dynamically made available to the data researcher in the form of a “ticker” on the UI which makes the project easily verifiable in real time as to how the project remains within budget.
The system where the platform can capture input from external content from websites in file form similar to the blocks or assets used internal to this platform.
The system whereby a message board is used to communicate needed content development to the data researcher community within the platform for use by the community or on behalf of a supplier.
The system whereby the message board is used by data researchers to communicate issues from the community to the platform for immediate attention and for the joint benefit of the community.
The system where virtual projects may simulate the conditions of real-world projects and properties for use as education and training curriculum.

Accordingly, a system for creating collaborative project data has been disclosed that, at the very least, meets all the stated objectives.

What is claimed is:

1. A system for creating collaborative project data, comprising the steps of:
creating a project by a project owner by inputting project information onto a platform and recorded to a public blockchain;
collecting data related to the project information by a plurality of data researchers;
recording the collected data on the public blockchain wherein the collected data is stamped with signatures of immutability.

2. The system of claim 1 further comprising the steps of inputting on the platform a project incentive provided by the project owner to the data researcher in return for the collected and assembled data.

3. The system of claim 1 further comprising the step of inputting on the platform criteria for selecting collected data.

4. The system of claim 1 wherein data is collected from information recorded on the blockchain from third parties.

5. The system of claim 1 wherein the platform assigns a value to the recorded collected data for payment of the value to the data researcher upon use of the recorded collected data.

6. The system of claim 1 wherein the blockchain is private and where confidential content is stored and accessed by those authorized.

7. The system of claim 3 further comprising the step of executing a smart contract between the project owner and all entities related to the selected content.

8. The system of claim 3 wherein inputs are made to the recorded content data upon scope of work milestones, validated completion metrics, and certified completion.

9. The system of claim 8 wherein the inputs trigger new execution provisions for the project.

10. The system of claim 8 wherein the platform initiates payment to selected entities upon acceptance of certified completion.

11. The system of claim 1 wherein the platform evaluates the researchers based on performance.

12. The system of claim 1 wherein the collected data is created using gaming systems.

13. The system of claim 1 wherein the collected data is created using a three dimensional gaming interface.

14. The system of claim 1 where the collected data is recorded to a private blockchain.

15. The system of claim 1 where the transactions paid to from any of the parties on the platform may choose to pay or be reimbursed in fiat currencies or any platform approved crypto-currencies.

16. The system of claim 1 where initial project specific data may be imported using 3D camera capture technology and imported into the platform for project development using real world measurements.

17. The system of claim 1 where initial project specific data may be imported using smart phone AR technology.

18. The system of claim 1 where initial project specific data may be imported using LIDAR technology.

19. The system of claim 1 where project specific assemblies are dynamically changed by the linkage of costs and product availabilities to a project by location.

20. The system of claim 1, where suppliers may integrate their product portfolios into the platform thereby leveraging the use of the platform as a sales tool.

21. The system of claim 1, where suppliers may utilize the network effect of the platform as a design platform for understanding changing customer behavior and interests related to projects.

22. The system of claim 1, where supplier SKUs, and data are automatically updated and made available to the community for joint beneficial use on any and all projects.

23. The system of claim 1, where projects may be commercial building projects.

24. The system of claim 1, where projects may be industrial projects.

25. The system of claim 1, where projects are infrastructure projects.

26. The system of claim 1, where projects are prototypes or simulations for use in any 3D environment.

27. The system of claim 1, where projects may be purely creative design environments for enjoyment only.

28. The system of claim 1, where the platform connects owners to contractors via a reverse auction type matchmaking system. Thereby giving high quality leads to contractors that they can review a budget, scope of work and photos, prior to accepting the lead upon their indication of interest to bid.

29. The system of claim 1 where the pricing of the project scope is dynamically made available to the data researcher in the form of a “ticker” on the UI which makes the project easily verifiable in real time as to how the project remains within budget.

30. The system of claim 1, where the platform can capture input from external content from websites in file form similar to the blocks or assets used internal to this platform.

31. The system of claim 1, whereby a message board is used communicate needed content development to the data researcher community within the platform for use by the community or on behalf of a supplier.

32. The system of claim 1, whereby the message board is used by data researchers to communicate issues from the community to the platform for immediate attention and for the joint benefit of the community.

33. The system of claim 1, where virtual projects may simulate the conditions of real-world projects and properties for use as education and training curriculum.
